(19) United States
(12) Patent Application Publication
(10) Pub. No.: US 2013/0005573 A1
(43) Pub. Date: Jan. 3, 2013

(54) COMPOSITIONS AND METHODS OF USE FOR KETONES AND ALDEHYDES AS HERBICIDES

(75) Inventors: R. Michael Roe, Raleigh, NC (US); George Kennedy, Raleigh, NC (US)

(73) Assignee: North Carolina State University, Raleigh, NC (US)

(21) Appl. No.: 13/575,553

(22) PCT Filed: Mar. 3, 2011
(86) PCT No.: PCT/US11/27001

§ 371 Date: Aug. 30, 2012

Related U.S. Application Data
(60) Provisional application No. 61/309,993, filed on Mar. 3, 2010.

(51) Int. Cl. A01N 35/02; A01P 1/00; A01P 3/00; A01P 21/00; A01P 7/02; A01P 7/04; A01P 11/00; A01P 17/00; A01P 13/00; A01P 5/00

(52) U.S. Cl. 504/118; 504/348

(57) ABSTRACT

Compositions and methods of use for ketones and aldehydes as herbicides are disclosed herein. According to an aspect, a method includes applying an effective amount of an herbicide composition comprising an acyclic, chemically-synthesized or plant-derived ketone or aldehyde of the invention to a locus where undesirable vegetation is to be controlled. The plant-derived or synthesized ketone may be a 2-undecanone. Further, various other acyclic ketones and aldehydes and their derivatives may be used.

### CROSS REFERENCE TO RELATED APPLICATIONS

This application is a 371 application of PCT International Patent Application PCT/US11/27001, filed on Mar. 3, 2011 and which claims priority to U.S. Provisional Patent Application No. 61/309,993, filed on Mar. 3, 2010, which are all hereby incorporated herein by reference in their entireties.

### TECHNICAL FIELD

The presently disclosed subject matter relates to compositions and methods of use for ketones and aldehydes as herbicides.

### BACKGROUND

Unwanted plant growth cause tremendous global economic losses by reducing crop yields and lowering crop quality. In the United States alone, agronomic crops must compete with hundreds of weed species. In particular, barnyardgrass, broadleaf weeds and sedges, by competition with other desired crops, cause extensive economic losses in the United States each year. Similar losses in agricultural production caused by weed infestations are problematic in many other countries as well.

There are many classes of chemicals which have been investigated for the control of unwanted plants in gardens, fields, paddies, orchards, parks, or for use along roadways, etc. Examples of herbicidal compound classes in which the chemical structures of members bear at least one aromatic group or one heterocyclic group in addition to at least one type of carbonyl functional group such as found in carboxylic acids, esters, amides, aldehydes and the like have been used for some time to control unwanted weeds (for an example of a compendium listing various herbicide classes.

Although significant advancements in plant control have been made, there is still a need for new, effective herbicides that are relatively economical to synthesize, safe, and that are easily obtained from natural sources. In addition, there is a need for effective herbicides that do not contain aromatic structures.

### BRIEF DESCRIPTION OF THE DRAWINGS

FIG. 1 is an image showing results of tests used to determine the herbicidal activity of a spray treatment comprising the use of a 5% (wt/vol) solution of 2-undecanone in ethanol in accordance with embodiments of the present disclosure;

FIGS. 2A, 2B, and 2C are images of results of other tests used to determine the herbicidal activity of an experimental spray treatment on henbit in accordance with embodiments of the present disclosure;

FIG. 3 is an image showing results of an experiment exemplifying the herbicidal activity of 2-undecanone on bean plants in accordance with embodiments of the present disclosure;

FIGS. 4A and 4B are images that exemplify the herbicidal activities that different concentrations of 2-undecanone in absolute ethanol produce when sprayed on bean plants in accordance with embodiments of the present disclosure;

FIGS. 5A, 5B and 5C are images showing the effects of spraying a 5% formulation of the test material in ethanol and ethanol control on test plots of grass in accordance with embodiments of the present disclosure; and

FIGS. 6A and 6B are images showing changes observed for an experiment in accordance with embodiments of the present disclosure.

### SUMMARY

Compositions and methods of use for ketones and aldehydes as herbicides are disclosed. A method includes applying an effective amount of an herbicide composition comprising an acyclic, chemically-synthesized or plant-derived ketone or aldehyde of the invention to a locus where undesirable vegetation is to be controlled. The plant-derived or synthesized ketone may be 2-undecanone. Further, various other acyclic ketones and aldehydes and their derivatives may be used.

### DETAILED DESCRIPTION

Disclosed herein are compositions and methods of use for ketones and aldehydes as herbicides. Embodiments of the present disclosure relate to compositions comprising acyclic carbonyl compounds, such as plant-derived acyclic ketones and aldehydes, and chemically-synthesized acyclic ketones and aldehydes, and their use as herbicidal agents, more particularly to compositions and techniques relating to herbicidal use of certain acyclic ketones and aldehydes, and related derivatives.

In accordance with embodiments of the present disclosure, the aromatic ketone class of herbicides used herein comprises a distinct class of carbonyl-containing compounds, by virtue of the presence of one or more aromatic rings, from the class of acyclic compounds of the present invention. In addition to the sub-groups of herbicides including the aromatic-ketones and the heterocyclic-ketones, there are also sub-groups comprising different types of carbocyclic-ketones. For example, a number of carbocyclic-ketone, -diketone and -triketone derivatives (as well as quinone derivatives) have been shown to be effective for applications as a herbicide. Mesotrione and Sulcotrione are two examples of carbocyclic, triketone-derived herbicidal formulations; the active, triketone components are in the group known as benzoyl cyclohexandione herbicides. Related to the carbocyclic-triketone subgroup of herbicides is the cyclohexandione subgroup. This subclass comprises a number of compounds, including those found in commercially-available herbicides such as: Butroxydim, Clefoxydim, Cycloxydim, Sethoxydim, and Tralkoxydim. These products are examples of formulated cyclohexanedione derivatives that may be used for applications as a herbicide.

Embodiments of the present disclosure may be applied as an effective and economical herbicide that is relatively economical to synthesize or relatively easy to obtain from natural sources. An object of present disclosure, therefore, is to provide acyclic ketone compounds and aldehyde compounds which are highly effective for controlling undesirable plant species and which are relatively easy to obtain through synthesis or from natural plant or animal sources. In an example, it is an object of the present disclosure to provide a technique for controlling undesirable plant species by use of an undecanone with an aromatic in the 1 position, distal to the ketone. It is also an object of the present disclosure to provide a technique for controlling undesirable plant species using the acyclic compounds according to embodiments of the present disclosure. These and other objects of the present disclosure will become more apparent from the detailed description thereof set forth below.

### DEFINITIONS

As used herein, phrases such as “a linear alkyl ketone” or “an acyclic alkyl ketone” or “a plant-derived ketone” refer to an herbicidally-active, straight chain hydrocarbon derivative comprising a chain of at least 11 and not more than 20 contiguously joined carbon-atoms in its chemical structure. In such a structure, at least one of the said contiguously-joined carbon-atoms of the compound's chain is attached to a substituent group by a double bond, wherein the doubly-bonded substituent comprises an oxygen atom, sulfur atom, or nitrogen atom. In addition, this substituted carbon atom is also attached either by carbon-carbon single bonds to two other adjacent carbon atoms of the chain (e.g., to form a ketone or a derivative), or by one C—C bond to an adjacent carbon atom in the chain and by one C—H bond to a hydrogen atom (e.g., to form an aldehyde or a derivative). The carbon chain in a compound according to embodiments of the present disclosure comprises carbon-carbon single bonds; and optionally, one or more carbon-carbon double bonds; and optionally, one or more carbon-carbon triple bonds. In addition to the (═O), (═S), or (═N—) substituent discussed above, the carbon chain of a linear alkyl ketone or acyclic alkyl ketone of the invention optionally can be substituted with one, two or three other independent groups. Examplary substituent groups include, but are not limited to: hydroxy, methoxy, ethoxy, thiomethyl, thioethyl, thiopropyl, oxo, imino, methyl, ethyl, vinyl, ethynyl, propyl, isopropyl, propenyl, propynyl, allyl, isopropenyl, propylidinyl, isopropylidinyl, n-butyl, s-butyl, isobutyl, t-butyl, butenyl, methallyl, butylidinyl, isobutylidinyl, butyryl, butadienyl, butenynyl, chloro, fluoro, bromo, iodo, cyano, azido, amido, amino, and the like. No linear alkyl ketone or aldehyde or acyclic alkyl ketone or aldehyde can comprise more than 3 substituents in addition to the carbonyl-type functionality {(═O), (═S), or (═N—)} discussed above, unless one or more fluorine-containing substituents is present on the contiguous carbon-chain; in this circumstance only, such a fluorine-containing compound can have a total number of 9 or fewer fluorine atoms in its molecular formula and can have only one other non-fluorine-containing substituent (in addition to the required carbonyl-like substituent) on the carbon-chain. Similarly, as used herein, phrases such as “a linear alkyl aldehyde,” “an acyclic alkyl aldehyde,” or “a plant-derived aldehyde” refer to an herbicidally-active straight chain hydrocarbon derivative that has the same constraints as the listed for ketones above. When the general terms “ketone” or “aldehyde” are used, it should also be understood for the purposes of the presently disclosed subject matter, that the general terms also comprise such hydrolyzable derivatives as acetals, ketals, oximes, oxime ethers, hydrazones, semicarbazones and the like. In the general sense, such derivatives can take the place of a keto- or aldehydro-group when referring to compounds in accordance with embodiments of the present disclosure.

General phrases such as “a compound” or “a carbonyl compound” are referring in a more general manner to a compound which has been defined by the present disclosure and which has herbicidal activity.

### Herbicidal Compounds

Formula I comprises active compounds comprising plant-derived ketones, plant-derived aldehydes, synthetic ketones, synthetic aldehydes and such derivatives which fall within the structural limitations provided by Formula I. Compounds of Formula I are disclosed below:

R′-a-b-c-d-e-f-g-h-i-CH₂—CH₂-x-y-z-R″
wherein the carbon-chain units: -a-b-, -d-e-, -g-h-, and -y-z- are independently: —CH₂—, —C(CH₃)₂—, —CH(Rₒ)—, —CH(R₁)—, —CRₒ(R₁)—, —CH(OH)—, —CH₂—CH₂—, CH₂—CH(OH)—, —CH═CH—, —C° C.—, —CF₂—, —CF═CH—, —CF═CF—, —CF₂—CF₂—, —CH═CF—, —CH(R)—CH₂—, —CR═CH—, —CH═CRₒ—, —CR(OH)—CH₂—, —CRₒ(OH)—, —CH(Rₒ)—CH₂—, -(L)HC—CH₂—, -(M)HC—CH₂—, —CH₂—CH(M)-, —CH═C(M)-, —C(L)=CH—, —C(M)=CH—, —CH(R₁)—CH₂—, —CH(Rₒ)—CH(R₁)—, —CF(R)—CH₂—, —CR═CF—, —CH₂—CH(R)—CH₂—, —CH₂—CH₂—CH(R)—, —CH(R)—CH₂—CH₂—, —CH₂—CH(R₁)—CH₂—, —CH₂—CF(R)—CH₂—, —CH₂—CH₂—CF(R)—, —CF(R)—CH₂—CH₂—, —CH₂CF(R₁)—CH₂—, —CF₂—CH(R)—CH₂—, —CF₂—CH₂—CH(R)—, —CH(R)—CF₂—CH₂—, —CF₂—CH(R₁)—CH₂—, —CH₂—CCH₃(OH)—, —CH₂—CH(R₁)—, —CH(R₁)—CH₂—CH₂—, —C(═O)—, —C(═S)—, —C(═NR′″)—, —C(═N—OH)—, —C(═N—OR′″)—, —C(═N—N(R′″)₂)—, —C(═N—NR′″-(C═O)R)—, or a C—C single bond serving to connect the two nearest carbon-chain moieties;
   the carbon-chain units: -c-, -f-, -i- and -x- are independently: —CH₂—, —C(CH₃)₂—, —CH(R)—, —CH(OH)—, —CH(F)—, —CH(M)-, —CH(L)-, —CH(Rₒ)—, —CH(R₁)—, —CRₒ(R₁)—, —CH(OCH₃)—, —C(OCH₃)₂—, —C(OCH₂CH₃)₂—, —CH₂—CH₂—, —CH₂—CH(OH)—, —CH═CH—, —C° C.—, —CF₂—, —CF═CH—, —CF═CF—, —CF₂—CF₂—, —CH═CF—, —CH(R)—CH₂—, —CR═CH—, —CH═CRₒ—, —CR(OH)—CH₂—, —CRₒ(OH)—, —CH(Rₒ)—CH₂—, -(L)HC—CH₂—, -(M)HC—CH₂—, —CH₂—CH(M)-, —CH═C(M)-, —C(L)=CH—, —C(M)=CH—, —CH(R₁)—CH₂—, —CH(Rₒ)—CH(R₁)—, —CF(R)—CH₂—, —CR═CF—, —CH(NRR′)—, —C(═O)—, C(═S)—, —C(═NR′″)—, —C(═N—OH)—, —C(═N—OR′″)—, —C(═N—N(R′″)₂)—, —C(═N—NR′″-(C═O)R)—, or a C—C single bond serving to connect the two nearest carbon-chain moieties;
—R′ and —R″ are moieties independently selected from the group consisting of: H—, CH₃—, CF₃—, CH₃—CH₂, CH₃—CH₂—CH₂—, CH₂═CH—, (CH₃)₂C═CH—, HC≡C—, —C(═O)R′″, —C(═O)R, CF₃—CH₂—, CF₃—CH₂—CH₂—, CF₂═CH—, (CH₃)(CF₃)C═CH—, FC° C.—, and RC° C.—;
—R and —Rₒ are moieties independently selected from the group consisting of: H—, CH₃—, CF₃—, CH₃—CH₂—, CH₂═CH—, (CH₃)₂C═CH—, HC° C.—, and R₁C° C.—;
—R₁ and —R′″ are moieties independently selected from the group consisting of: H—, CH₃—, CH₃—CH₂—, CH₃—CH₂—CH₂—, (CH₃)₂CH—, CH₃—CH₂—CH₂—CH₂—, (CH₃)₂CH—CH₂—, CH₃—CH₂—(CH₃)CH—, (CH₃)₃C—, CH₃—CH₂—CH₂—CH₂—CH₂—, (CH₃)₂CH—CH₂—CH₂—, CH₃—CH₂—HC(CH₃)—CH₂—, (CH₃)₃C—CH₂—, CH₃—CH₂—(CH₃)₂C—, and (CH₃)₂CH(CH₃)CH—;
-L and -M, independently are: —H, —CH₃, —OCH₃, —OCH₂CH₃, —O—CH(CH₃)₂, —OCH₂CH₂CH₃, —CH₂(OH), —CH₂OCH₃, —CH₂OCH₂CH₃, —CH₂O—CH(CH₃)₂, —CH₂OCH₂CH₂CH₃, —OC(═O)R′″, —OC(═O)R, —CH₂SCH₃, —CH₂SCH₂CH₃, —CH₂SCH(CH₃)₂, —CH₂SCH₂CH₂CH₃, —SCH₃, —SCH₂CH₃, —SCH(CH₃)₂, —SCH₂CH₂CH₃, —CH₂F, —CH₂Cl, —CH₂Br, —CH₂I, —CH₂CN, —CH₂N₃, —CH₂N(CH₃)₂, —CH₂N(CH₂CH₃)₂, —CN, —N₃, —F, —Cl, —Br, or —I;
and
provided that when a carbonyl derivative of a ketone or aldehyde is present in lieu of the —(CO)— moiety of the parent ketone or aldehyde, said carbonyl derivative is selected from the group consisting of: —C(═S)—, —C(═NR′″)—, —C(═N—OH)—, —C(═N—OR′″)—, —C(═N—N(R′″)₂)—, —{C(═N—NR′″-(C═O)R)}—, —C(OCH₃)₂— and —C(OCH₂CH₃)₂—;
and
provided that: in the compound of Formula I, the sum of all carbon atoms forming the contiguous carbon-chain extending from the terminus of the longest carbon-moiety in —R′ to the terminus of the longest carbon-moiety in —R″ is between 20 and 11, inclusive;
   and
there are no heteroatoms in the contiguous chain;
there are no heteroatoms in such a contiguous chain;
and
at least one, but not more than two members of the group consisting of: -a-b-, -c-, -d-e-, -f-, -g-h-, -i-, -x-, and -y-z- independently must be: —C(═O)—, —C(═S)—, —C(═NR′″)—, —C(═N—OH)—, —C(═N—OR′″)—, —C(═N—N(R′″)₂)—, —C{(═N—NR′″-(C═O)R)}—, —C(OCH₃)₂—, or —C(OCH₂CH₃)₂—;
and
there can be no more than four substituents bonded to the contiguous carbon-chain unless one or more substituents is a fluoro-containing group;
it is provided that when one or more substituents on the contiguous carbon-chain is —F or a fluoro-containing group, then a total of 9 or fewer fluorine atoms can be present in the molecular formula of the compound; and
it is further provided that only one other non-fluorine-containing substituent in addition to the required a (═O), (═S), imino-type substituent or derivative of said (═O), (═S), or imino-type substituent, can be present on the contiguous carbon-chain when one or more fluorine atoms are included in the molecular structure.

Compounds illustrative of those of Formula I, for example, comprise compounds of Formula II:

R′—C(═O)—CH₂—(CH₂)ₚ—CH₂—R″
wherein R′— and R″— independently are H—, CH₃—, CF₃—, CH₃—CH₂—, CH₃—CH₂—CH₂—, CH₂═CH—, (CH₃)₂C═CH— or HC° C.—;
and
p is an integer selected from 2, 3, 4, 5, 6, 7, 8, 9, 10, 11, 12, 13, 14, 15, 16 and 17, such that the contiguous carbon-carbon chain in a compound so-formed consists of more than 10 and less than 21 carbon atoms, exclusive.

Compounds illustrative of those of Formula II, for example, include compounds of Formula III:

CH₃—C(═O)—CH₂—(CH₂)ₚ—CH₂—CH₂—CH₂—CH₃
wherein p is an integer selected from: 4, 5, 6, 7, 8, and 9.

Example compounds for use in accordance with embodiments of the present disclosure include 2-undecanone, 2-dodecanone, 2-tridecanone, 2-tetradecanone, 3-undecanone, 3-dodecanone, 3-tridecanone and 3-tetradecanone. An example compound of Formula III is 2-undecanone.

Several of the compounds of Formula III such as 2-undecanone (methyl nonyl ketone) and tridecanone (methyl undecyl ketone) are commercially available. For example, 2-undecanone (methyl nonyl ketone) is commercially available from the Sigma-Aldrich Company, P.O. Box 2060, Milwaukee, Wis. 53201 USA as catalog number U-130-3. 2-tridecanone (methyl undecyl ketone) is commercially available from the Sigma-Aldrich Company, P.O. Box 2060, Milwaukee, Wis. 53201 USA as catalog number 17,283-9.

Active compounds in accordance with embodiments of the present disclosure can also be chemically-synthesized. Compounds of Formula I herein may be produced in accordance with techniques known to those skilled in the art, or where novel, may be produced by variations of known techniques which will be apparent to those skilled in the art. In addition, many of the compounds of Formula I herein can be isolated by extraction from natural sources. Materials from various sources such as those obtained from trees, bushes, grasses, algae, sponges, animals, bacteria, and the like, using extractive methods which are known in the art or variations of those extractive methods which will be apparent to those skilled in the art can be used to obtain many of the types of compounds of Formula I.

### Herbicidal Methods and Formulations

The presently disclosed subject matter provides herbicidal compounds, compositions comprising said herbicidal compounds and the use of such herbicidal compounds and compositions for controlling undesirable vegetation comprising applying an effective amount of an herbicide composition comprising a plant-derived ketone, a plant-derived aldehyde, a linear alkyl aldehyde, or a linear alkyl ketone to a locus where undesirable vegetation is to be controlled.

As used herein, “locus of vegetation” refers to the vegetation and its environment (i.e. the area in which the vegetation grows or may grow). The term “controlling undesirable vegetation” as used herein, means to reduce the overall vigor of the plant, affecting its overall homeostatis, affecting overall plant growth, causing the death of plant parts resulting from overall effects on plant homeostatis, for example application to plant parts but not limited to leaves or flowers, and plant death. Plant death is defined as ecological death where the plant health is reduced enough so that environmental factors ultimately produce physiological death. Physiological death is the irreversible cessation of plant functions such as but not limited to photosynthesis, respiration, water balance and solute transport, reproduction and the like. The term “controlling undesirable vegetation” as used in the present disclosure also includes direct physiological death as defined herein.

Liquid formulations may be aqueous-based or non-aqueous (i.e., organic solvents), or combinations thereof, and may be employed as foams, gels, suspensions, emulsions, microemulsions, emulsifiable concentrates, powders or the like. The ingredients may include rheological agents, surfactants, emulsifiers, dispersants or polymers. Undecanone, or other linear alkyl ketones or aldehydes may also be used as a gas.

The compounds of Formula I according to the presently disclosed subject matter may have strong herbicidal activity and a broad activity spectrum when used on the soil or on above-ground parts of plants. They may also be suitable for selective control of monocotyledonous and dicotyledonous weeds in monocotyledonous and dicotyledonous crops, both by the pre-emergence and by the post-emergence method.

The active compounds can be converted into formulations, such as solutions, emulsions, wettable powders, suspensions, powders, dusts, pastes, soluble powders, granules, suspo-emulsion concentrates, natural and synthetic substances impregnated with active compound, and microencapsulations in polymeric substances.

These formulations are produced in a known manner, for example by mixing the active compounds with extenders, that is to say liquid solvents and/or solid carriers, optionally with the use of surfactants, that is to say emulsifiers and/or dispersants and/or foam formers. If the extender used is water, it is also possible to use, for example, organic solvents as auxiliary solvents. Liquid solvents which are mainly suitable are: aromatics, such as xylene, toluene or alkylnaphthalenes, chlorinated aromatics and chlorinated aliphatic hydrocarbons, such as chlorobenzenes, chloroethylenes or methylene chloride, aliphatic hydrocarbons, such as cyclohexane or paraffins, for example petroleum fractions, mineral and vegetable oils, alcohols, such as butanol or glycol, and also their ethers and esters, ketones, such as acetone, methyl ethyl ketone, methyl isobutyl ketone or cyclohexanone, strongly polar solvents, such as dimethylformamide and dimethyl sulphoxide, and water.

Suitable solid carriers are: for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example crushed and fractionated natural rocks, such as calcite, marble, pumice, sepiolite, dolomite and synthetic granules of inorganic and organic meals, and granules of organic material, such as sawdust, coconut shells, maize cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates; suitable dispersants are: for example lignosulphite waste liquors and methylcellulose.

Tackifiers, such as carboxymethylcellulose, natural and synthetic polymers in the form of powders, granules or latices, such as gum arabic, polyvinyl alcohol and polyvinyl acetate, and also natural phospholipids, such as cephalins and lecithins, and synthetic phospholipids can be used in the formulations. Other possible additives are mineral and vegetable oils.

It is possible to use dyestuffs, such as inorganic pigments, for example iron oxide, titanium oxide, Prussian blue, and organic dyestuffs, such as alizarin dyestuffs, azo dyestuffs and metal phthalocyanine dyestuffs, and trace nutrients, such as salts of iron, manganese, boron, copper, cobalt, molybdenum and zinc in these formulations to impart special qualities to the compositions.

The formulations generally comprise between 0.1 and 95 percent by weight of active compound, between 0.5 and 90% for example, and more particularly, for example, between 1% and 50% by weight of active compound. Compositions which comprise weight per volume percentages of active compounds such as, for example, but not limited to, 1%, 2%, 3%, 4%, 5%, 10%, 20%, 25%, 30%, 40%, and 50% are also contemplated for use. Other compositions comprising active compounds are contemplated for use wherein the active compounds are used in the range of 1-10 wt/vol, or in the range of 10-20 wt/vol or in the range of 20-30 wt/vol. In an example, it is contemplated to use a concentration of plant-derived ketone in a herbicidal composition that is between 0.11% (wt/vol) to 100% (wt/vol) of the herbicidal composition.

For controlling weeds, the active compounds, as such or in the form of their formulations, can also be used as mixtures with known herbicides, finished formulations or tank mixes being possible.

Possible components for the mixtures are known herbicides, for example acetochlor, acifluorfen(-sodium), aclonifen, alachlor, alloxydim(-sodium), ametryne, amicarbazone, amidochlor, amidosulfuron, anilofos, asulam, atrazine, azafenidin, azimsulfuron, benazolin(-ethyl), benfuresate, bensulfuron(-methyl), bentazon, benzobicyclon, benzofenap, benzoylprop(-ethyl), bialaphos, bifenox, bispyribac(-sodium), bromobutide, bromofenoxim, bromoxynil, butachlor, butroxydim, butylate, cafenstrole, caloxydim, carbetamide, carfentrazone(-ethyl), chlomethoxyfen, chloramben, chloridazon, chlorimuron(-ethyl), chlornitrofen, chlorsulfuron, chlortoluron, cinidon(-ethyl), cinmethylin, cinosulfuron, clethodim, clodinafop(-propargyl), clomazone, clomeprop, clopyralid, clopyrasulfuron(-methyl), cloransulam(-methyl), cumyluron, cyanazine, cybutryne, cycloate, cyclosulfamuron, cycloxydim, cyhalofop(-butyl), 2,4-D, 2,4-DB, 2,4-DP, desmedipham, diallate, dicamba, diclofop(-methyl), diclosulam, diethatyl(-ethyl), difenzoquat, diflufenican, diflufenzopyr, dimefuron, dimepiperate, dimethachlor, dimethametryn, dimethenamid, dimexyflam, dinitramine, diphenamid, diquat, dithiopyr, diuron, dymron, epoprodan, EPTC, esprocarb, ethalfluralin, ethametsulfuron(-methyl), ethofumesate, ethoxyfen, ethoxysulfuron, etobenzanid, fenoxaprop(—P-ethyl), flamprop(-isopropyl), flamprop(-isopropyl-L), flamprop(-methyl), flazasulfuron, fluazifop(—P-butyl), fluazolate, flucarbazone, flufenacet, flumetsulam, flumiclorac(-pentyl), flumioxazin, flumipropyn, flumetsulam, fluometuron, fluorochloridone, fluoroglycofen(-ethyl), flupoxam, flupropacil, flurpyrsulfuron(-methyl, -sodium), flurenol(-butyl), fluridone, fluoroxypyr(-meptyl), flurprimidol, flurtamone, fluthiacet(-methyl), fluthiamide, fomesafen, glufosinate(-ammonium), glyphosate(-isopropylammonium), halosafen, haloxyfop(-ethoxyethyl), haloxyfop(-p-methyl), hexazinone, imazamethabenz(-methyl), imazamethapyr, imazamox, imazapic, imazapyr, imazaquin, imazethapyr, imazosulfuron, iodosulfuron, ioxynil, isopropalin, isoproturon, isouron, isoxaben, isoxachlortole, isoxaflutole, isoxapyrifop, lactofen, lenacil, linuron, MCPA, MCPP, mefenacet, mesotrione, metamitron, metazachlor, methabenzthiazuron, metobenzuron, metobromuron, (alpha-)metolachlor, metosulam, metoxuron, metribuzin, metsulfuron(-methyl), molinate, monolinuron, naproanilide, napropamide, neburon, nicosulfuron, norflurazon, orbencarb, oryzalin, oxadiargyl, oxadiazon, oxasulfuron, oxaziclomefone, oxyfluorfen, paraquat, pelargonic acid, pendimethalin, pentoxazone, phenmedipham, picolinafen, piperophos, pretilachlor, primisulfuron(-methyl), prometryn, propachlor, propanil, propaquizafop, propisochlor, propyzamide, prosulfocarb, prosulfuron, pyraflufen(-ethyl), pyrazolate, pyrazosulfuron(-ethyl), pyrazoxyfen, pyribenzoxim, pyributicarb, pyridate, pyriminobac(-methyl), pyrithiobac(-sodium), quinchlorac, quinmerac, quinoclamine, quizalofop(—P-ethyl), quizalofop(—P-tefuryl), rimsulfuron, sethoxydim, simazine, simetryn, sulcotrione, sulfentrazone, sulfometuron(-methyl), sulfosate, sulfosulfuron, tebutam, tebuthiuron, tepraloxydim, terbuthylazine, terbutryn, thenylchlor, thiafluamide, thiazopyr, thidiazimin, thifensulfuron(-methyl), thiobencarb, tiocarbazil, tralkoxydim, triallate, triasulfuron, tribenuron(-methyl), triclopyr, tridiphane, trifluralin, triflusulfuron, and tritosulfuron.

A mixture with other known active compounds, such as fungicides, insecticides, acaricides, nematicides, bird repellents, etc. is also possible. Such an herbicide composition comprises a compound of Formula I and further comprises at least one additional agent selected from the group consisting of insecticides, acaricides, rodenticides, fungicides, bactericides, nematocides, herbicides, fertilizers, plant nutrients, agents which improve soil structure, bird repellents, and growth-regulating agents.

The active compounds can be used as such, in the form of their formulations or in the use forms prepared therefrom by further dilution, such as ready-to-use solutions, suspensions, emulsions, powders, pastes and granules. They are used in the customary manner, for example by watering, spraying, atomizing, or scattering.

The active compounds can be applied both before and after emergence of the plants. They can also be incorporated into the soil before sowing.

The amount of active compound used can vary within a relatively wide range. It depends essentially on the nature of the desired effect. In general, the amounts used are between 1 g and 100 kg of active compound per hectare of soil surface, between 5 g and 20 kg per ha for example; and more particularly between 50 g and 5 kg per ha for example.

All application methods which are conventionally used in agriculture, for example pre-emergence application, post-emergence application and seed treatment, as well as various methods and techniques, for example the controlled release of active ingredients, are suitable for the use according to the present disclosure of the compounds of the Formula I or of compositions comprising them. To this end, the active ingredient in solution is applied to mineral carriers for granules or to polymerized granules (urea/formaldehyde) and dried. If appropriate, an additional coating can be applied (coated granules), which allows the active ingredient to be released in a controlled manner over a specific period of time.

The compounds of Formula I can be employed as herbicides as such, i.e. as obtained from synthesis. However, they may be processed in the customary manner together with the auxiliaries conventionally used in the art of formulation, for example to give emulsifiable concentrates, directly sprayable or dilutable solutions, dilute emulsions, wettable powders, soluble powders, dusts, granules or microcapsules. The application methods such as spraying, atomizing, dusting, wetting, scattering or pouring, as well as the type of composition, are chosen to suit the intended aims and the prevailing circumstances.

The formulations, i.e. the compositions, preparations or products which comprise the active ingredient of Formula I or at least one active ingredient of Formula I and, as a rule, one or more solid or liquid formulation auxiliaries, are prepared in the known manner, for example by intimately mixing and/or grinding the active ingredients together with the formulation auxiliaries, for example solvents or solid carriers. Furthermore, surface-active compounds (surfactants) may additionally be used when preparing the formulations.

Suitable surface-active compounds are, depending on the nature of the active ingredient of Formula Ito be formulated, nonionic, cationic and/or anionic surfactants and surfactant mixtures which have good emulsifying, dispersing and wetting properties. Example surfactants as described in, for example, “McCutcheon's Detergents and Emulsifiers Annual” MC Publishing Corp. Ridgewood N.J., 1981, Stache, H., “Tensid-Taschenbuch” [“Surfactants Guide”], Carl Hanser Veriag, Munich/Vienna, 1981 and M. and J. Ash, “Encyclopedia of Surfactants”, Vol I-III, Chemical Publishing Co., New York, 1980-81, the disclosure of which is incorporated herein in its entirety, are suitable for preparing herbicidal compositions.

Solid diluents may be used, but also other solids, either mined or manufactured, may be used. The more absorptive diluents may be used for wettable powders and the denser ones for dusts. In an example, solubility under 0.1% may be in suspension concentrates; solution concentrates may be stable against phase separation at 0° C. All formulations can contain minor amounts of additives to reduce foaming, caking, corrosion, microbiological growth, etc.

The methods of making such compositions are well known. Solutions are prepared by simply mixing the ingredients. Fine solid compositions are made by blending and, usually, grinding as in a hammer or fluid energy mill. Suspensions may be prepared by wet milling. Granules and pellets may be made by spraying the active material upon preformed granular carriers or by agglomeration techniques.

Active compounds according to embodiments of the present disclosure can be used as defoliants, and, especially, as weed killers. By weeds in the broadest sense there are to be understood all plants which grow in locations where they are undesired. Whether the substances act as total or selective herbicides may depend on the amount used. However, the use of the active compounds according to embodiments of the present disclosure is not restricted to these genera, but also extends in the same manner to other plants.

Depending on the concentration, active compounds according to embodiments of the present disclosure are suitable for total weed control, for example on industrial terrain and rail tracks and on paths and areas with or without tree growth. Equally, the active compounds according to embodiments of the present disclosure can be employed for controlling weeds in perennial crops, for example forests, ornamental tree plantings, orchards, vineyards, citrus groves, nut orchards, banana plantations, coffee plantations, tea plantations, rubber plantations, oil palm plantations, cocoa plantations, soft fruit plantings and hop fields, on lawns and turf and pastures and for selective weed control in annual crops.

Vegetation that may be controlled in accordance with the present disclosure can include, but is not limited to, monocots or dicots, including soybean, cotton, alfalfa, canola, flax, tomato, sugar beet, sunflower, potato, tobacco, corn, wheat, rice, lettuce, rape, volunteer crop plants, weeds, and the like. In addition, other suitable cultivated plants are those like sugar cane, millet, maize, rice and cereals (wheat, rye, barley, oats). Crops are also to be understood as including those which have been rendered tolerant to herbicides or classes of herbicides by means of conventional plant-breeding or genetic-engineering methods.

Undesirable vegetation that may be controlled in accordance with the present disclosure may include a wide variety of grass and broadleaf weeds, including, but not limited to:
Polygonaceae weeds: wild buckwheat (Polygonum convolvulus), pale smartweed (Polygonum lapathifolium), Pensylvania smartweed (Polygonum pensylvanicum), ladysthumb (Polygonum persicaria), curly dock (Rumex crispus), bitter dock (Rumex obtusifolius), Japanese knotweed (Poligonum cuspidatum);
Portulaceae weeds: common purslane (Portulaca oleracea);
Caryophyllaceae weeds: common chickweed (Stellaria media);
Chenopodiaceae weeds: common lambsquarters (Chenopodium album), summer cypress (Kochia scoparia);
Amaranthaceae weeds: redroot pigweed (Amaranthus retroflexus), smooth pigweed (Amaranthus hybridus);
Cruciferae weeds: wild radish (Raphanus raphanistrum), wild mustard (Sinapis arvensis), shepherds purse (Capsella bursa-pastoris);
Legminosae weeds: hemp sesbania (Sesbania exaltata), sickle pod (Cassia obtusifolia), Florida beggarweed (Desmodium tortuosum), white clover (Trifolium repens);
Malvaceae weeds: velvetleaf (Abutilon theophrasti), pricky sida (Sida spinosa);
Violaceae weeds: field pansy (Viola arvensis), wildpansy (Viola tricolor);
Rubiaceae weeds: bedstraw (Galium aparine);
Convolvulaceae weeds: ivyleaf morningglory (Ipomoea hederacea), tall morningglory (Ipomoea purpurea), entireleaf morningglory (Ipomoea hederacea var integriuscula), whitestar (Ipomoea lacunosa), field bindweed (Convolvulus arvensis);
Labiatae weeds: purple deadnettle (Lamium purpureum), henbit (Lamium amplexicaule);
Solanaceae weeds: jimsonweed (Datura stramonium), black nightshade (Solanum nigrum);
Scrophulariaceae weeds: persian speedwell (Veronica persica), ivyleaf speedwell (Veronica hederaefolia);
Compositae weeds: common cocklebur (Xanthium pensylvanicum), wild sunflower (Helianthus annuus), scentless chamomile (Matricaria perforata or inodora), corn marigold (Chrysanthemum segetum), pineapple weed (Matricaria matricarioides), commonragweed (Ambrosia artemisiifolia), giant ragweed (Ambrosia trifida), horseweed (Erigeron canadensis), Japanese mugwort (Artemisia princeps), tall goldenrod (Solidago altissima);
Boraginaceae weeds: forget-me-not (Myosotis arvensis);
Asslepiadaceae weeds: milkweed (Asclepias syriaca);
Euphorbiaceae weeds: sun spurge (Euphorbia helioscopia), spurge (Euphorbia maculata);
Gramineae weeds: barnyard grass (Echinochloa crus-galli), green foxtail (Setaria viridis), giant foxtail (Setaria faberi), southern crabgrass (Digitaria sanguinalis), goose grass (Eleusine indica), annual bluegrass (Poa annua), black grass (Alopecurus myosuroides), wild oats (Avena fatua), Johnson grass (Sorghum halepense), quack grass (Agropyron repens), downy brome (Bromus tectorum), Bermuda grass (Cynodone dactylon), fall panicum (Panicum dichotomiflorum), Texas panicum (Panicumtexanum), shatter cane (Sorghum vulgare), broadleaf signalgrass (Brachiaria platyphylla);
Commelinaceae weeds: asiatic dayflower (Commelina communis);
Equisetaceae weeds: field horsetail (Equisetum arvense);
Cryperaceae weeds: rice flatsedge (Cyperus iria), purple nutsedge (Cyperus rotundus), yellow nutsedge (Cyperus esculentus);

The presently disclosed compositions may also be used for control of trees, and plants both on land, in water, on the surface of water, on other vegetation such as, but not limited to, trees, in aquatic and marine environments and on soils of different types and levels of water content. Use may also include the development of plants resistance to the herbicide as described herein, for example but not limited to plant breeding, development of transgenic plants, chemical treatments, and the like, so that undesirable plants can be killed while the modified plants are unaffected. Similar discrimination between desirable plants and undesirable plants could be achieved by the method of application, for example but not limited to targeted applications, timing of treatments based on seasons, time of day or other environmental parameters, or pretreatment with compounds which will protect the plant from the action of the herbicide for example, but not limited to, cotton seed oil, soybean oil, etc.

The following examples are offered by way of illustration and not by way of limitation.

### Example Experiment 1

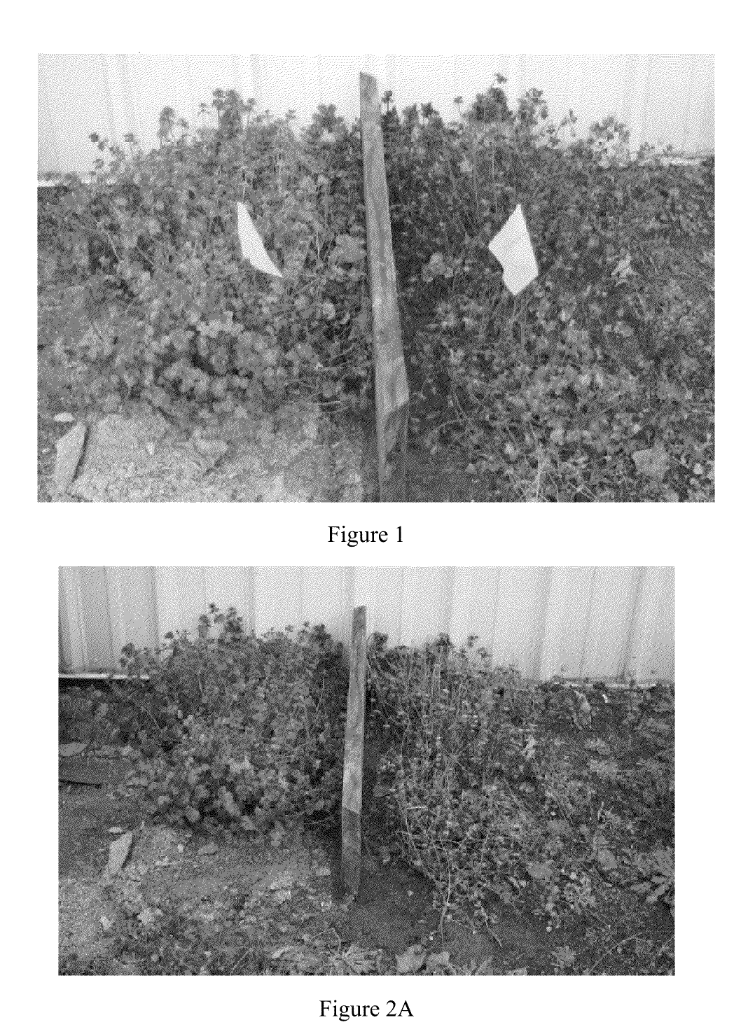

FIG. 1 is an image showing results of tests used to determine the herbicidal activity of a spray treatment comprising the use of a 5% solution of 2-undecanone in ethanol. The image was captured approximately 2 hours after the spray-applications of materials to henbit under winter field conditions. Both of the weed groups shown in FIG. 1 are groups of wild henbit. Treatment of the group of henbit plants on the left side of FIG. 1 (control group) consisted of spraying the group with 100 ml of the carrier as a fine mist; the carrier comprised absolute ethanol (without the herbicide). Treatment of the group of henbit plants on the right side of FIG. 1 (treatment group) consisted of spraying the group with 100 ml of the herbicide/carrier mixture (5 wt % of 2-undecanone/100 mL solution) as a fine mist. The image was captured 2 hours after treatment.

Because the sprayer produced a very fine mist in each case, and there may have been spray drift (from the wind) during these treatments, evaporation and dissipation of these misty sprays occurred to some degree before and while each spray hit its targeted group of plant material. As a consequence of the experimental conditions encountered, spray-treatments of these plant groups did not reach the point of “run-off” in either case. The text results show that significant changes in the herbicide-treated plant group have occurred after approximately two hours. This result was observable in the herbicide-treated group, when compared to the control group approximately 2 hours after the treatments, even though lower levels of coverage (to less than “run off” levels) occurred in both groups. All plants in the treatment group receiving the 5% solution of 2-undecanone and carrier had lost much of their green color and vitality, and had turned yellow after approximately 2 hours. No significant changes in color or vitality levels were noted for the plants in the control group after 2 hours.

### Example Experiment 2

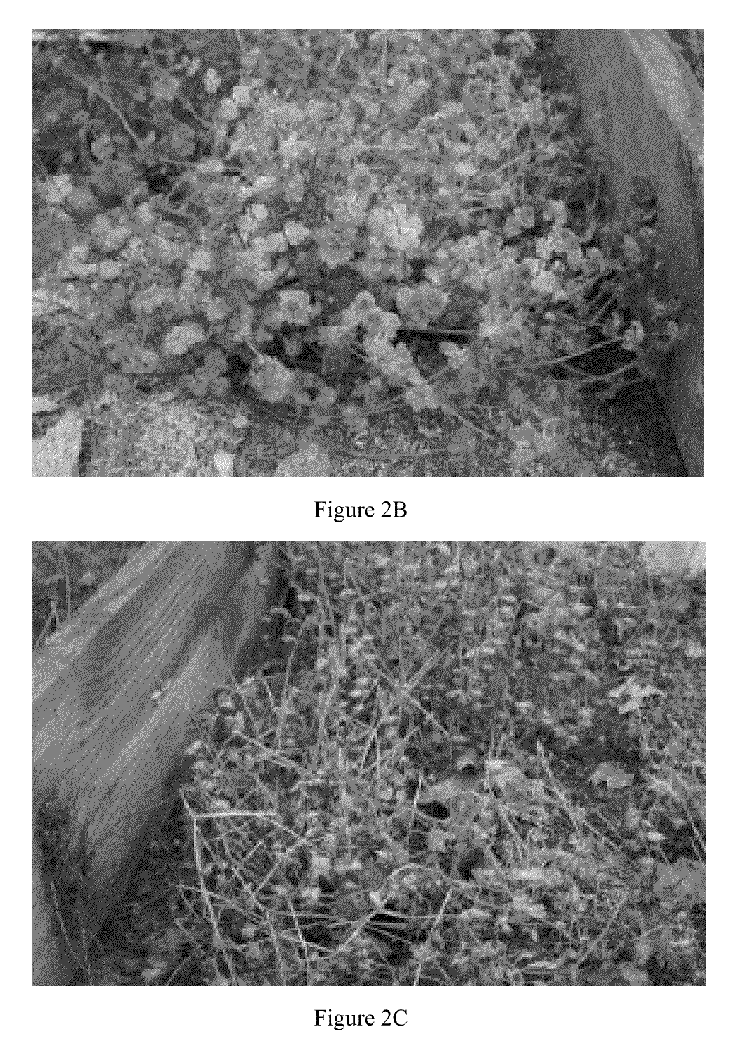

Experiment 2 is similar to Experiment 1, in that it tests the herbicidal activity of an experimental spray treatment on henbit. The herbicidal spray treatments of Experiment 2 comprised the use of a 20% solution of 2-undecanone in ethanol (20 wt % of 2-undecanone/100 mL solution). The experimental results are featured in FIGS. 2A, 2B and 2C, the henbit treatment group receiving the 2-undecanone spray treatment is located on the right side of the image shown in FIG. 2A. The control group was treated with a spray comprising just the carrier (absolute ethanol); the henbit treatment group receiving this carrier-only spray treatment (control group) is located on the left side of the image shown in FIG. 2A. The image was captured 4 days after the spray-applications of these materials to the groups of henbit under winter field conditions.

The spray conditions for Experiment 2 (using 20% 2-undecanone versus carrier only) were very similar to the spray conditions described for Experiment 1 (using 5% 2-undecanone vs carrier only). Due to the windy conditions and the fine mist produced by the sprayer during the experiment, treatments to achieve “run off” levels of liquid on the henbit plants in each group were not possible, so the plants of each treatment group were exposed to lower levels of these sprayed materials than if they had been sprayed to “run off” levels. Even so, it was clear from the experimental results that the 2-undecanone composition was herbicidal. At 4 days after the treatments, not only were the leaves of the henbit plants affected by the 2-undecanone treatment in a similar manner to the description given above for the Experiment 1 results, but in addition, the stems of these treated henbit plants had become significantly weakened and had become flaccid. In contrast, the henbit plants in the carrier control group showed no significant changes from their earlier pre-treatment state.

In Experiment 2, a group of wild henbit plants (on the left of the image shown in FIG. 2A) was treated by spraying with 100 ml of a spray comprising just absolute ethanol, whereas the henbit group shown on the right of FIG. 2A was treated with 100 ml of a spray comprising 20% (wt/vol) of 2-undecanone in absolute ethanol. The image shown in FIG. 2A was captured 4 days after the treatments. The image shown in FIG. 2B is a close-up view of the plants from the carrier-only control group, 4 days after treatment. The image shown in FIG. 2C is a close-up view of the plants from the 2-undecanone treatment group, 4 days after treatment. A comparison of the experimental results clearly showed that significant differences had arisen between these two groups of henbit; the control group was still thriving 4 days following treatment, whereas plants in the ketone-treated group appeared to be dead or dying.

### Example Experiment 3

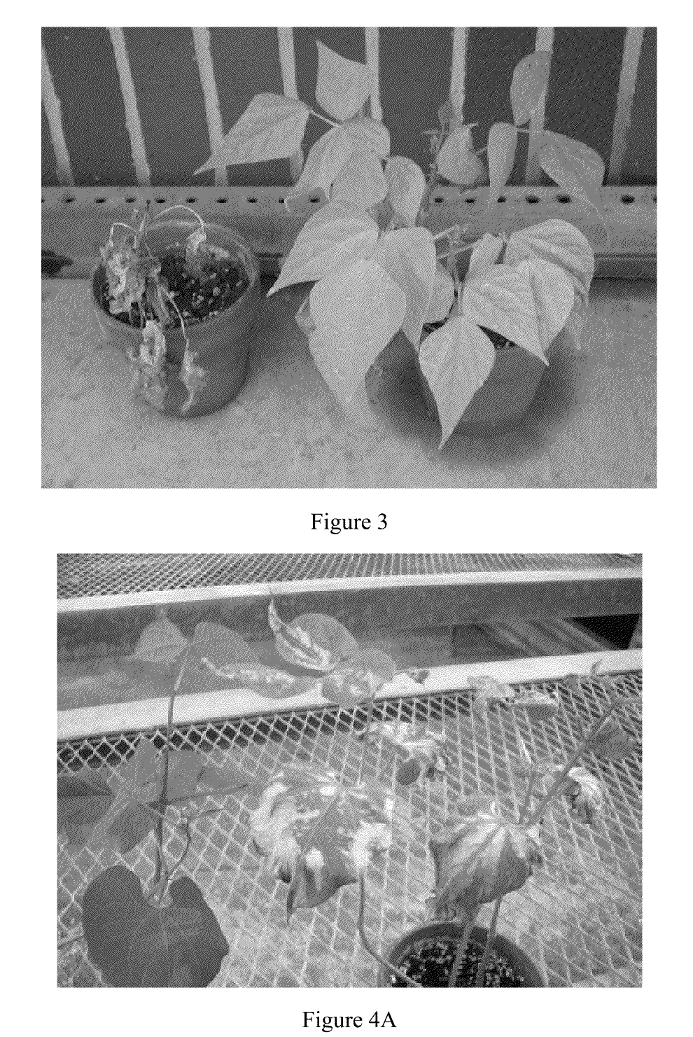

Experiment 3 exemplifies the herbicidal activity of 2-undecanone on bean plants. The visual results associated with this experiment are shown in the image shown in FIG. 3. The bean plant on the left in FIG. 3 was treated with a 20% solution (wt/vol) of 2-undecanone in a carrier comprising absolute ethanol. The bean plant on the right was treated with the absolute ethanol carrier only. Treatments were made by spraying each plant until “run off” levels were achieved. The image shown in FIG. 3 was captured approximately 2 weeks after these spray treatments, however, we noted on the day of the treatments that the plant treated with 2-undecanone (on the left side of FIG. 3) started to change its appearance and character shortly after the spray treatment was complete. In fact, this plant's appearance 30 minutes after the treatment with 2-undecanone was very similar to the way it appears in the image on the left side of FIG. 3; the only observed difference noted 30 minutes after treatment that differed significantly from the observations noted 2 weeks after treatment was that the leaves of the treated bean plant were still dark green at the 30 minute time point, whereas the leaves of this plant were yellow after two weeks. In contrast, the plant on the right (ethanol control) never differed in appearance from the no-spray controls (not shown). Similar results were obtained using a spray treatment comprising a 10% solution of 2-undecanone in ethanol (not shown). All treatments of the bean plants described above were performed in North Carolina during the summer months under a shelter; the bean plants were protected from the elements but were watered regularly. The plants also received direct sunlight for about 8 hours from approximately noon until sunset.

### Example Experiment 4

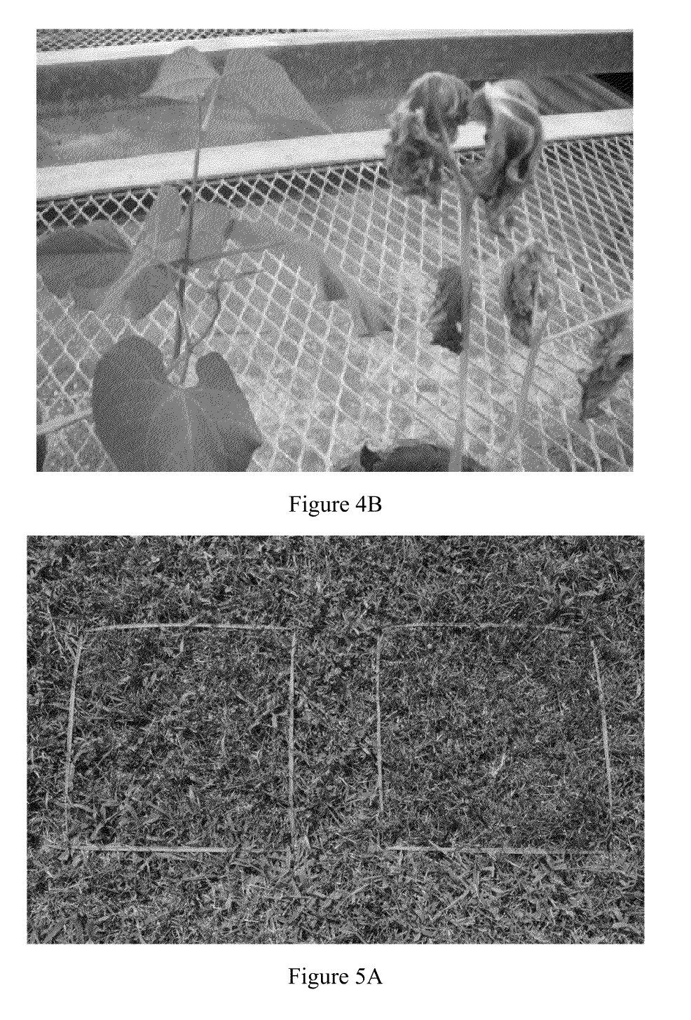

Experiment 4 tested the herbicidal activities of different concentrations of 2-undecanone in absolute ethanol when sprayed on bean plants. The control spray for comparison was absolute ethanol. The results of the experiment are exemplified in the images shown in FIGS. 4A and 4B. FIG. 4A shows a comparison of the effects of treating bean plants with a spray comprising a 1% (wt/vol) solution of 2-undecanone in absolute ethanol (right side of the image) versus the effects of treating a bean plant with the control spray (on left side of the image). The images were captured 6 days after the treatments were made. These treatments consisted of spraying the plants “to runoff” levels with the appropriate spray while the plant grew in a green house. FIG. 4B shows a comparison of the effects of treating bean plants with a spray comprising a 5% (wt/vol) solution of 2-undecanone in absolute ethanol (right side of the image) versus the effects of treating with the control spray (on left side of the image). The images were captured 6 days after the treatments were made.

### Example Experiment 5

This experiment was conducted in a greenhouse setting. Tomato seedlings in 4 to 6 true-leaf stage and 3-5 inch tall potato plants were treated with a fine mist spray comprising a solution of >2% 2-undecanone in 95% ethanol. The spray was applied to the foliage as a fine mist using an airbrush and this treatment resulted in the death of the plants' foliage within 24 hours; plant death subsequently followed. Similar applications of 2-undecanone to tomato plants at concentrations of less than 1% in 95% ethanol resulted in the death of foliage followed by re-foliation some days later.

### Example Experiments 6 and 7

Two experiments were initiated that tested the activity of an acyclic ketone on a common monocotyledon. The test plots comprised similar areas of wild-type grass. The area of each test plot of grass was defined to be the area within a square measuring approximately 15 inches on a side. The experiments were conducted using two different formulations of the same test material: the formulation tested in Experiment 6 comprised a 5% (wt/vol) mixture of undecanone in absolute ethanol; the formulation tested in Experiment 7 comprised a 5% (wt/vol) mixture of undecanone in water.

A measured amount of each formulation was sprayed onto its appropriate test area using a hand held spray bottle; the spray bottle produced a fine mist in each case. The effects of the sprayed formulations were noted at different time intervals after spraying. The details of each experiment are provided separately below.

### Example Experiment 6

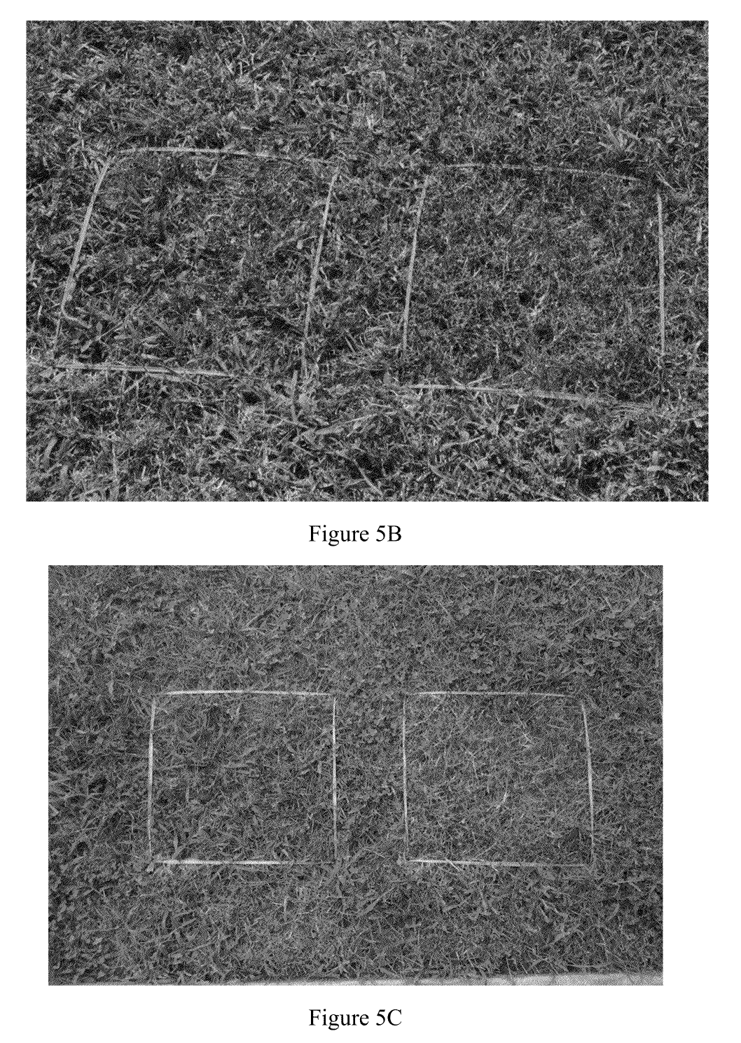

In Experiment 6, 40 ml of a 5% formulation of the test material in ethanol (wt/vol) was evenly sprayed on one of two adjacent test plots of grass. This treated plot was located on the right side of the test plot pair. The adjacent test plot (left; control plot) was sprayed in an identical fashion with a spray bottle containing 40 mL of the ethanol carrier as a control; the time difference for completing the spraying of the two grassy test plots was less than 2 minutes. The effects of the spray formulations on the test plots were noted over time and images were captured at several time points for later comparisons (see FIGS. 5A, 5B and 5C for images). FIGS. 5A, 5B and 5C are images showing the effects of spraying a 5% formulation of the test material in ethanol and ethanol control on test plots of grass in accordance with embodiments of the present disclosure.

Visible differences were observed within a 30 minute period following the spray applications of control and test compound formulations comprising ethanol. Grass treated with the test compound appeared brown (see FIG. 5A, right side of the image), whereas the control plot showed no visible changes (see FIG. 5A, left side of the image) after 30 minutes. The herbicidal toxicity of the test material was noted to increase with time, however, the appearance of the grass in the control area did not change significantly over the time course of the experiment. The appearance of the plots at the one-hour time point are shown in the FIG. 5B image, and the appearance of the plots at the twenty four-hour time point are shown in the FIG. 5C image.

### Example Experiment 7

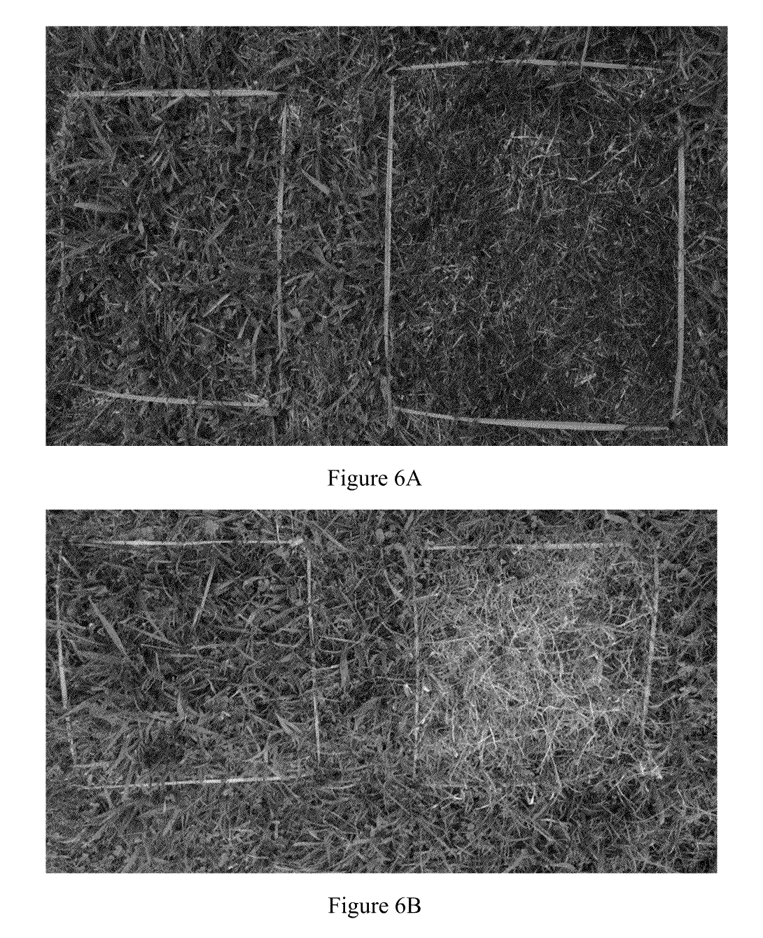

The conditions and amounts of materials used in Experiment 7 were similar to those employed in Experiment 6, with the exception that both the formulation comprising the active ingredient and the solution of carrier comprised water in the place of ethanol. In Experiment 7, the early toxicity effects were delayed compared to the early toxicity effects noted in Experiment 6. In Experiment 7, the first toxicity effects were noted for the active treatment area about 2-3 hours after spraying. The image of FIG. 6A shows the changes in appearance of the treated grassy area at the 3 hour time point. Interestingly, the visual appearances of both treatment pair areas of Experiment 7 and Experiment 6 (i.e., EtOH carrier pair vs water carrier pair) were similar at 24 hours. The appearance of the areas treated with the formulation comprising water were photographed at the 24 hour time point and can be seen in the image of FIG. 6B.

The compositions disclosed herein may be suitably applied to control the rate of growth, development and reproduction of the plant, while not killing the plant. Further, the compositions disclosed herein may be suitably applied to reduce water concentration in a plant or water concentration in products produce or derived from a plant, irrespective of plant death. In another example, the compositions disclosed herein may be suitably applied to reduce the chlorophyll content of the plant, irrespective of plant death. In another example, the compositions disclosed herein may be suitably applied to soil or water and through the natural or directed movement of the treated soil and water for causing an effect on the plant consistent with the activity of the embodiments disclosed herein. In another example, compositions disclosed herein may be applied to soil or water and through the natural or directed movement of seeds or the plant to the treated soil or water for causing an effect on the plant consistent with the activity of the embodiments disclosed herein.

While the embodiments have been described in connection with the particular embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

1. A method for controlling undesirable vegetation comprising applying an effective amount of an herbicide composition comprising a ketone or aldehyde or comprising a carbonyl derivative of said ketone or aldehyde to a locus where undesirable vegetation is to be controlled, wherein said ketone or aldehyde is a compound of Formula I:
R′-a-b-c-d-e-f-g-h-i-CH₂—CH₂-x-y-z-R″ Formula I
wherein the carbon-chain units: -a-b-, -d-e-, -g-h-, and -y-z- are independently: —CH₂—, —C(CH₃)₂—, —CH(Rₒ)—, —CH(R₁)—, —CRₒ(R₁)—, —CH(OH)—, —CH₂—CH₂—, CH₂—CH(OH)—, —CH═CH—, —C° C.—, —CF₂—, —CF═CH—, —CF═CF—, —CF₂—CF₂—, —CH═CF—, —CH(R)—CH₂—, —CR═CH—, —CH═CRₒ—, —CR(OH)—CH₂—, —CRₒ(OH)—, —CH(Rₒ)—CH₂—, -(L)HC—CH₂—, -(M)HC—CH₂—, —CH₂—CH(M)-, —CH═C(M)-, —C(L)=CH—, —C(M)=CH—, —CH(R₁)—CH₂—, —CH(Rₒ)—CH(R₁)—, —CF(R)—CH₂—, —CR═CF—, —CH₂—CH(R)—CH₂—, —CH₂—CH₂—CH(R)—, —CH(R)—CH₂—CH₂—, —CH₂—CH(R₁)—CH₂—, —CH₂—CF(R)—CH₂—, —CH₂—CH₂—CF(R)—, —CF(R)—CH₂—CH₂—, —CH₂CF(R₁)—CH₂—, —CF₂—CH(R)—CH₂—, —CF₂—CH₂—CH(R)—, —CH(R)—CF₂—CH₂—, —CF₂—CH(R₁)—CH₂—, —CH₂—CCH₃(OH)—, —CH₂—CH(R₁)—, —CH(R₁)—CH₂—CH₂—, —C(═O)—, —C(═S)—, —C(═NR′″)—, —C(═N—OH)—, —C(═N—OR′″)—, —C(═N—N(R′″)₂)—, —C(═N—NR′″—(C═O)R)—, or a C—C single bond serving to connect the two nearest carbon-chain moieties;
the carbon-chain units: -c-, -f-, -i- and -x- are independently: —CH₂—, —C(CH₃)₂—, —CH(R)—, —CH(OH)—, —CH(F)—, —CH(M)-, —CH(L)-, —CH(Rₒ)—, —CH(R₁)—, —CRₒ(R₁)—, —CH(OCH₃)—, —C(OCH₃)₂—, —C(OCH₂CH₃)₂—, —CH₂—CH₂—, —CH₂—CH(OH)—, —CH═CH—, —C° C.—, —CF₂—, —CF═CH—, —CF═CF—, —CF₂—CF₂—, —CH═CF—, —CH(R)—CH₂—, —CR═CH—, —CH═CRₒ—, —CR(OH)—CH₂—, —CRₒ(OH)—, —CH(Rₒ)—CH₂—, -(L)HC—CH₂—, -(M)HC—CH₂—, —CH₂—CH(M)-, —CH═C(M)-, —C(L)=CH—, —C(M)=CH—, —CH(R₁)—CH₂—, —CH(Rₒ)—CH(R₁)—, —CF(R)—CH₂—, —CR═CF—, —CH(NRR′)—, —C(═O)—, —C(═S)—, —C(═NR′″)—, —C(═N—OH)—, —C(═N—OR′″)—, —C(═N—N(R′″)₂)—, —C(═N—NR′″—(C═O)R)—, or a C—C single bond serving to connect the two nearest carbon-chain moieties;
—R′ and —R″ are moieties independently selected from the group consisting of: H—, CH₃—, CF₃—, CH₃—CH₂—, CH₃—CH₂—CH₂—, CH₂═CH—, (CH₃)₂C═CH—, HC° C.—, —C(═O)R′″, —C(═O)R, CF₃—CH₂—, CF₃—CH₂—CH₂—, CF₂═CH—, (CH₃)(CF₃)C═CH—, FC° C.—, and RC° C.—;
—R and —Rₒ, are moieties independently selected from the group consisting of: H—, CH₃—, CF₃—, CH₃—CH₂—, CH₂═CH—, (CH₃)₂C═CH—, HC° C.—, and R₁C° C.—;
—R₁ and —R′″ are moieties independently selected from the group consisting of: H—, CH₃—, CH₃—CH₂—, CH₃—CH₂—CH₂—, (CH₃)₂CH—, CH₃—CH₂—CH₂—CH₂—, (CH₃)₂CH—CH₂—, CH₃—CH₂—(CH₃)CH—, (CH₃)₃C—, CH₃—CH₂—CH₂—CH₂—CH₂—, (CH₃)₂CH—CH₂—CH₂—, CH₃—CH₂—HC(CH₃)—CH₂—, (CH₃)₃C—CH₂—, CH₃—CH₂—(CH₃)₂C—, and (CH₃)₂CH(CH₃)CH—;
-L and -M, independently are: —H, —CH₃, —OCH₃, —OCH₂CH₃, —O—CH(CH₃)₂, —OCH₂CH₂CH₃, —CH₂(OH), —CH₂OCH₃, —CH₂OCH₂CH₃, —CH₂O—CH(CH₃)₂, —CH₂OCH₂CH₂CH₃, —OC(═O)R′″, —OC(═O)R, —CH₂SCH₃, —CH₂SCH₂CH₃, —CH₂SCH(CH₃)₂, —CH₂SCH₂CH₂CH₃, —SCH₃, —SCH₂CH₃, —SCH(CH₃)₂, —SCH₂CH₂CH₃, —CH₂F, —CH₂Cl, —CH₂Br, —CH₂I, —CH₂CN, —CH₂N₃, —CH₂N(CH₃)₂, —CH₂N(CH₂CH₃)₂, —CN, —N₃, —F, —Cl, —Br, or —I;
and
provided that when a carbonyl derivative of a ketone or aldehyde is present in lieu of the —(CO)— moiety of the parent ketone or aldehyde, said carbonyl derivative is selected from the group consisting of: —C(═S)—, —C(═NR′″)—, —C(═N—OH)—, —C(═N—OR′″)—, —C(═N—N(R′″)₂)—, —{C(═N—NR′″—(C═O)R)}—, —C(OCH₃)₂— and —C(OCH₂CH₃)₂—;
and
provided that: in the compound of Formula I, the sum of all carbon atoms forming the contiguous carbon-chain extending from the terminus of the longest carbon-moiety in —R′ to the terminus of the longest carbon-moiety in —R″ is between 20 and 11, inclusive;
and
there are no heteroatoms in the contiguous chain;
and
at least one, but not more than two members of the group consisting of: -a-b-, -c-, -d-e-, -f-, -g-h-, -i-, -x-, and -y-z- independently must be: —C(═O)—, —C(═S)—, —C(═NR′″)—, —C(═N—OH)—, —C(═N—OR″)—, —C(═N—N(R′″)₂)—, —C{(═N—NR′″—(C═O)R)}—, —C(OCH₃)₂—, or —C(OCH₂CH₃)₂—;
and
there are no more than four substituents bonded to the contiguous carbon-chain unless one or more substituents is a fluoro-containing group;
it is provided that when one or more substituents on the contiguous carbon-chain is —F or a fluoro-containing group, then a total of 9 or fewer fluorine atoms can be present in the molecular formula of the compound; and
it is further provided that only one other non-fluorine-containing substituent, in addition to the required (═O), (═S), imino-type substituent or derivative of said (═O), (═S), or imino-type substituent, can be present on the contiguous carbon-chain when one or more fluorine atoms are included in the molecular structure.

2. The method of claim 1, wherein said ketone is a plant-derived ketone.

3. The method of claim 2, wherein said plant-derived ketone is 2-undecanone.

4. The method of claim 2, wherein said plant-derived ketone is 2-tridecanone.

5. The method of claim 1, wherein said herbicide composition further comprises a carrier.

6. The method of claim 5, wherein said carrier comprises an alcohol.

7. The method of claim 5, wherein said carrier comprises ethanol.

8. The method of claim 5, wherein said carrier comprises water.

9. The method of claim 5, wherein the concentration of plant-derived ketone in said herbicidal composition is between 0.1% (wt/vol) to 100% (wt/vol) of the herbicidal composition.

10. The method of claim 5, wherein said herbicide composition further comprises at least one additional agent selected from the group consisting of insecticides, acaricides, rodenticides, fungicides, bactericides, nematocides, herbicides, fertilizers, plant nutrients, agents which improve soil structure, bird repellents, and growth-regulating agents.

11. The method of claim 5, wherein said undesirable vegetation to be controlled is a weed selected from the group consisting of Polygonaceae weeds, Portulaceae weeds, Caryophyllaceae weeds, Chenopodiaceae weeds, Amaranthaceae weeds, Cruciferae weeds, Legminosae weeds, Malvaceae weeds, Violaceae weeds, Rubiaceae weeds, Convolvulaceae weeds, Labiatae weeds, Solanaceae weeds, Scrophulariaceae weeds, Compositae weeds, Boraginaceae weeds, Asslepiadaceae weeds, Euphorbiaceae weeds, Gramineae weeds, Commelinaceae weeds, Equisetaceae weeds, and Cryperaceae weeds.

12. A method for controlling undesirable vegetation comprising applying an effective amount of an herbicide composition comprising a ketone, wherein the ketone is an undecanone.

13. The method of claim 12, wherein the carbonyl moiety of the undecanone is at any position on the contiguous carbon chain.

14. The method of claim 13, wherein the ketone is 2-undecanone.

15. The method of claim 12, wherein said herbicide composition further comprises a carrier.

16. The method of claim 14, wherein said carrier comprises one of alcohol and water.
